(19) United States
(12) Patent Application Publication
(10) Pub. No.: US 2019/0086123 A1
(43) Pub. Date: Mar. 21, 2019

(54) MULTIFUNCTION FLAT PLATE HEAT EXCHANGER

(71) Applicant: Shandong Sanqi Energy Co., Ltd., Shandong Province (CN)

(72) Inventor: Hsiu-Lin Peng, Kaohsiung City (TW)

(73) Assignee: Shandong Sanqi Energy Co., Ltd., Shandong Province (CN)

(21) Appl. No.: 16/131,053

(22) Filed: Sep. 14, 2018

(30) Foreign Application Priority Data
Sep. 19, 2017 (CN) 201710845004.3

(51) Int. Cl. F24S 80/50; F24S 10/55; F24S 10/75; F24S 80/30; F24S 80/40; F24S 80/60

(52) U.S. Cl. CPC F24S 80/50; F24S 10/55; F24S 10/75; F24S 2080/502; F24S 80/40; F24S 80/60; F24S 80/30

(57) ABSTRACT

A multifunction flat plate heat exchanger including a heat exchanging flat plate, a spectrum selectivity absorption layer, a light transmissive layer, at least one heat-conductive structure, and at least one airflow driving device is provided. The heat exchanging flat plate has a first plate surface, a second plate surface and a pipe tunnel located between the first plate surface and the second plate surface. The spectrum selectivity absorption layer covers the first plate surface. The light transmissive layer covers the spectrum selectivity absorption layer, and the light transmissive layer and the first plate surface are respectively located at two opposite sides of the spectrum selectivity absorption layer. The heat-conductive structure is disposed on the second plate surface. The airflow driving device is disposed at one side of the heat exchanging flat plate and the heat-conductive structure.

### CROSS-REFERENCE TO RELATED APPLICATION

This application claims the priority benefit of Chinese application serial no. 201710845004.3, filed on Sep. 19, 2017. The entirety of the above-mentioned patent application is hereby incorporated by reference herein and made a part of this specification.

### BACKGROUND OF THE INVENTION

### 1. Field of the Invention

The invention relates to a heat exchanger. More particularly, the invention relates to a multifunction flat plate heat exchanger.

### 2. Description of Related Art

In a conventional flat plate solar heat collector, only enable a surface of a heat collection flat plate faces toward the sun to convert solar radiation into thermal energy to be transferred into a heat-conductive medium. A heat insulation measure is disposed on the other surface of the heat collection flat plate back to the sun, so as to prevent heat dissipation. As such, the other surface of the heat collection flat plate back to the sun is unable to be used for heat collection or heat exchange to dissipate excessive heat in the flat plate heat collector to the outside. Alternatively, the other surface of the heat collection flat plate back to the sun is unable to be used for heat exchange with other types of heat energy in the external environment (e.g., heat energy in the air) to absorb heat. On the other hand, a conventional heat pump or an air conditioning evaporator is unable to effectively collect solar radiation to be converted into solar heat energy for conducting heat exchange.

A heat collector which may absorb solar radiation and collect various types of energies is disclosed in China utility model patent CN 204438543 U; nevertheless, technical means for implementing the collector are not specifically disclosed.

### SUMMARY OF THE INVENTION

The invention provides a multifunction flat plate heat exchanger with both functions of collecting solar heat energy and heat energy of air, and dissipating internal excessive heat to the outside.

According to an embodiment of the invention, a multifunction flat plate heat exchanger includes a heat exchanging flat plate, at least one heat-conductive structure, and at least one airflow driving device. The heat exchanging flat plate has a first plate surface and a second plate surface opposite to each other, and a pipe tunnel located between the first plate surface and the second plate surface. The pipe tunnel is configured to allow a heat-conductive medium to flow therein. A spectrum selectivity absorption layer covers the first plate surface. A light transmissive layer covers the spectrum selectivity absorption layer, wherein the light transmissive layer and the first plate surface are respectively located at two opposite sides of the spectrum selectivity absorption layer. The at least one heat-conductive structure is disposed on the second plate surface. The at least one heat-conductive structure defines at least one flow path with the second plate surface and has a plurality of first through holes communicated with the at least one flow path. The at least one airflow driving device is disposed at one side of the heat exchanging flat plate and the heat-conductive structure. The at least one airflow driving device is disposed corresponding to the at least one flow path. The at least one airflow driving device is configured to drive outside air to flow into the at least one flow path or drive air inside the at least one flow path to be exhausted to an outside.

In the multifunction flat plate heat exchanger according to an embodiment of the invention, the heat-conductive structure includes a plurality of convex portions and a plurality of concave portions disposed alternately, wherein each of the convex portions is separated from the second plate surface, and each of the concave portions is bonded to the second plate surface.

In the multifunction flat plate heat exchanger according to an embodiment of the invention, a number of the at least one flow path is plural, and each of the convex portions is connected to one of the concave portions and another one of the concave portions adjacent to each other, so as to define one of the flow paths with the second plate surface.

In the multifunction flat plate heat exchanger according to an embodiment of the invention, the first through holes are located on the convex portions.

In the multifunction flat plate heat exchanger according to an embodiment of the invention, the heat-conductive structure includes a first plate portion and a plurality of second plate portions, wherein the first plate portion is bonded to the second plate surface through the second plate portions.

In the multifunction flat plate heat exchanger according to an embodiment of the invention, a number of the at least one flow path is plural, wherein the second plate portions are arranged in parallel between the first plate portion and the second plate surface, and the first plate portion, the second plate portions, and the second plate surface define the flow paths.

In the multifunction flat plate heat exchanger according to an embodiment of the invention, the first through holes are located on the first plate portion and are respectively located between one of the second plate portions and another one of the second plate portions adjacent to each other.

In the multifunction flat plate heat exchanger according to an embodiment of the invention, the multifunction flat plate heat exchanger further includes an outer cover covering the second plate surface and the heat-conductive structure, wherein the outer cover has a plurality of second through holes, and the second through holes are communicated with the at least one flow path through the first through holes.

In the multifunction flat plate heat exchanger according to an embodiment of the invention, the second through holes of the outer cover are configured to be selectively closed.

In the multifunction flat plate heat exchanger according to an embodiment of the invention, the at least one airflow driving device includes an axial flow fan, a crosscurrent fan, a centrifugal fan, an air extracting pump, a blower, or a turbine.

According to another embodiment of the invention, a multifunction flat plate heat exchanger includes two heat exchanging flat plates, two spectrum selectivity absorption layers, two light transmissive layers, two heat-conductive structures, and at least two airflow driving devices. Each of the two heat exchanging flat plates has a first plate surface and a second plate surface opposite to each other, and a pipe tunnel located between the first plate surface and the second plate surface. The pipe tunnel of each of the two heat exchanging flat plates is configured to allow a heat-conductive medium to flow therein. The two heat exchanging flat plates are pivoted to each other. The two first plate surfaces are arranged in parallel to each other and flushed with each other in an unfolded state. The two first plate surfaces face each other and are overlapped with each other in a folded state. The two spectrum selectivity absorption layers respectively cover the two first plate surfaces. The two light transmissive layers respectively cover the two spectrum selectivity absorption layers, wherein each of the two light transmissive layers and the corresponding first plate surface are respectively located at two opposite sides of the corresponding spectrum selectivity absorption layer. The two heat-conductive structures are respectively disposed on the two second plate surfaces. Each of the two heat-conductive structures defines at least one flow path with the second plate surface of the corresponding heat exchanging flat plate and has a plurality of through holes communicated with the at least one flow path. One of the at least two airflow driving devices is disposed at one side of one of the two heat exchanging flat plates and of one of the heat-conductive structures, and the other one of the at least two airflow driving devices is disposed at one side of the other one of the two heat exchanging flat plates and one side of the other one of the two heat-conductive structures. The at least two airflow driving devices are respectively disposed corresponding to the at least two flow paths, and each of the at least two airflow driving devices is configured to drive outside air to flow into the corresponding at least one flow path or drive air inside the corresponding at least one flow path to be exhausted to an outside.

To sum up, the multifunction flat plate heat exchanger provided by the embodiments of the invention can not only absorb solar radiation heat energy and external heat energy of air but also dissipate excessive heat in the multifunction flat plate heat exchanger to the outside. In other words, with favorable heat collection and heat dissipation efficiencies, the multifunction flat plate heat exchanger of the embodiments of the invention is able to provide increased applications.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a multifunction flat plate heat exchanger according to an embodiment of the invention.

FIG. 2 is a schematic partial exploded view of the multifunction flat plate heat exchanger of FIG. 1.

FIG. 3 is a schematic partial cross-sectional view of a heat exchanging flat plate of FIG. 2.

FIG. 4 and FIG. 5 are respectively schematic side views of the multifunction flat plate heat exchanger of FIG. 1 before and after being rotated.

FIG. 6 is a schematic partial exploded view of a multifunction flat plate heat exchanger according to another embodiment of the invention.

FIG. 7 and FIG. 8 are respectively schematic views of a multifunction flat plate heat exchanger in an unfolded state and in a folded state according to still another embodiment of the invention.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

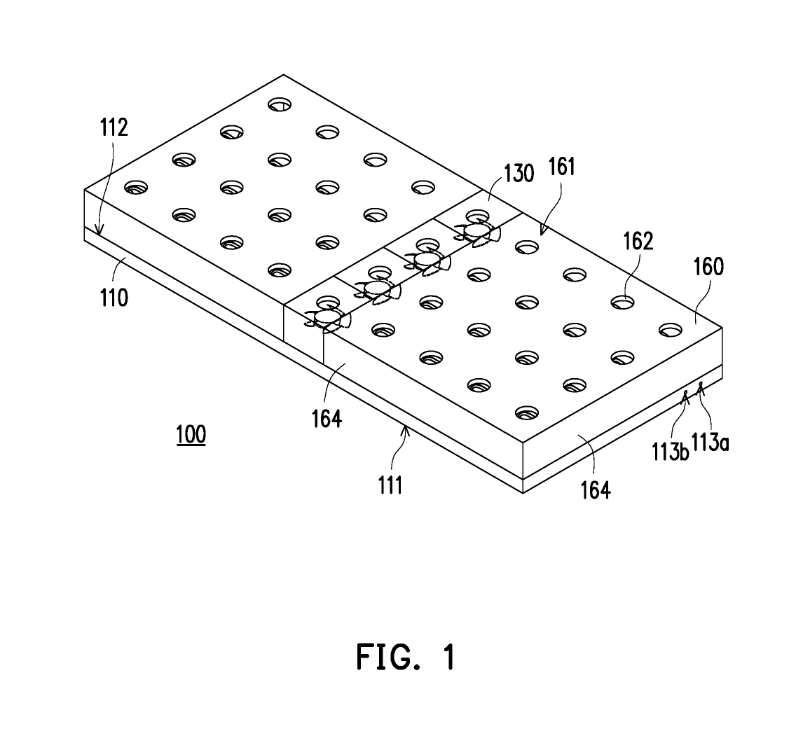

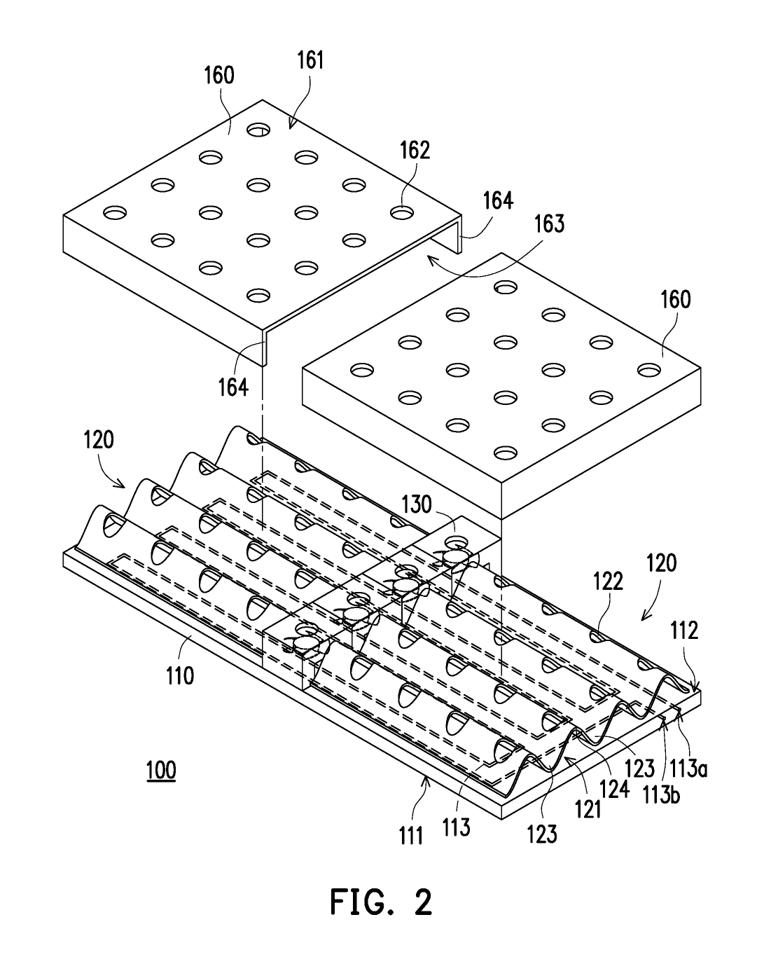

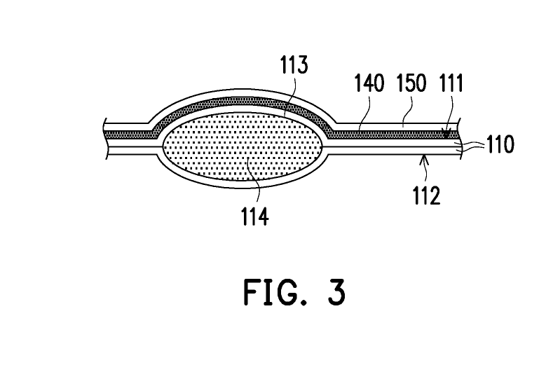

FIG. 1 is a schematic view of a multifunction flat plate heat exchanger according to an embodiment of the invention. FIG. 2 is a schematic partial exploded view of the multifunction flat plate heat exchanger of FIG. 1. FIG. 3 is a schematic partial cross-sectional view of a heat exchanging flat plate of FIG. 2. Referring to FIG. 1 to FIG. 3, in the present embodiment, a multifunction flat plate heat exchanger 100 includes a heat exchanging flat plate 110, a heat-conductive structure 120, and at least one airflow driving device 130 (a plurality of the airflow driving devices 130 are schematically shown). Herein, the heat exchanging flat plate 110 may be formed by pressing two heat-conductive plate together, and a material of the heat-conductive plate material may include copper, aluminum, other metal materials or an alloy. The heat exchanging flat plate 110 has a first plate surface 111 and a second plate surface 112 opposite to each other, and a pipe tunnel 113 located between the first plate surface 111 and the second plate surface 112. That is to say, the pipe tunnel 113 is located inside the heat exchanging flat plate 110 and has a corresponding loop design based on actual requirements. The first plate surface 111 is configured to be positioned to face toward the sun and to convert solar radiation into heat energy to be transferred to a heat-conductive medium 114 in the pipe tunnel 113. Further, the pipe tunnel 113 is configured to allow the heat-conductive medium 114 to flow therein, and the heat-conductive medium 114 may be liquid, gas, refrigerant, or other types of thermal conductive fluid. Generally, the pipe tunnel 113 has an inlet 113a and an outlet 113b opposite to each other, wherein a low-temperature heat-conductive medium 114 enters into the pipe tunnel 113 from the inlet 113a and is converted into a high-temperature heat-conductive medium 114 after absorbing heat and then flows out of the pipe tunnel 113 from the outlet 113b. In contrast, the high-temperature heat-conductive medium 114 may enter into the pipe tunnel 113 from the inlet 113a and be converted into the low-temperature heat-conductive medium 114 after releasing heat and then flows out of the pipe tunnel 113 from the outlet 113b.

The multifunction flat plate heat exchanger 100 further includes a spectrum selectivity absorption layer 140 and a light transmissive layer 150. The spectrum selectivity absorption layer 140 covers the first plate surface 111 and may be a solar spectrum selectivity absorption layer. The spectrum selectivity absorption layer 140 is configured to absorb solar radiation and convert part of the solar radiation into heat energy or convert part of the solar radiation into electricity energy and enables the heat energy to be transferred to the heat-conductive medium 114 in the pipe tunnel 113 through the first plate surface 111. On the other hand, the light transmissive layer 150 covers the spectrum selectivity absorption layer 140, wherein the light transmissive layer 150 and the heat exchanging flat plate 110 are respectively located at two opposite sides of the spectrum selectivity absorption layer 140. With the light transmissive layer 150 being disposed, sunlight is allowed to pass through, heat dissipation is reduced, and moreover, the spectrum selectivity absorption layer 140 is prevented from being damaged by external forces.

The heat-conductive structure 120 is disposed on the second plate surface 112 and may be fixed to the second plate surface 112 by means of hot melt welding, ultrasonic welding, laser welding, chemical lamination, or mechanical lamination, etc., and further defines at least one flow path 121 (a plurality of the flow paths 121 are schematically shown) with the second plate surface 112. A material of the heat-conductive structure 120 may include copper, aluminum, other metal materials or an alloy. In the present embodiment, the heat-conductive structure 120 may be a wave structure and has a plurality of first through holes 122 respectively communicated with the flow paths 121. Further, the heat-conductive structure 120 includes a plurality of convex portions 123 and a plurality of concave portions 124 disposed alternately, wherein each of the convex portions 123 is separated from the second plate surface 112, and each of the concave portions 124 is bonded to the second plate surface 112. Any adjacent two concave portions 124 are connected through one of the convex portions 123, so as to define one of the flow paths 121 with the second plate surface 112. In other words, any two adjacent convex portions 123 are connected through one of the concave portions 124. On the other hand, the first through holes 122 are respectively located on the convex portions 123, and since each of the convex portions 123 is separated from the second plate surface 112, a degree of communication between the first through holes 122 and the corresponding flow paths 121 may be enhanced. In other embodiments, a number of the heat-conductive structure may be two or more, and the heat-conductive structure may be stacked on the second plate surface.

The airflow driving devices 130 may be axial flow fans, crosscurrent fans, centrifugal fans, air extracting pumps, blowers, or turbines and are disposed at one side of the heat exchanging flat plate 110 and the heat-conductive structure 120. In the present embodiment, the airflow driving devices 130 may be carried by the heat exchanging flat plate 110 and, for example, are disposed on the second plate surface 112. Further, the airflow driving devices 130 are respectively disposed corresponding to the flow paths 121. Moreover, the airflow driving devices 130 are disposed based on a principle of driving air inside the flow paths 121 to be exhausted to an outside. Alternatively, the airflow driving devices 130 may be disposed based on a principle of driving outside air to flow into the flow paths 121.

A plurality of operation mechanisms of the airflow driving devices 130 are illustrated as follows: when a temperature of the heat-conductive medium 114 in the pipe tunnel 113 is lower than a temperature of outside air, the airflow driving devices 130 may be activated to drive outside air to flow into the flow paths 121. Heat energy of air flowing into the flow paths 121 may thus be transferred to the heat-conductive medium 114 in the pipe tunnel 113 through the heat-conductive structure 120 and the second plate surface 112. When the first plate surface 111 absorbs and converts the solar radiation energy into heat energy and transfers the heat energy to the heat-conductive medium 114 in the pipe tunnel 113, and enables the temperature of the heat-conductive medium 114 in the pipe tunnel 113 to be greater than the temperature of outside air, the airflow driving devices 130 may be closed. As such, heat dissipation of the heat-conductive medium 114 in the pipe tunnel 113 to the outside through the heat-conductive structure 120 and the second plate surface 112 may be reduced. When the temperature of the heat-conductive medium 114 in the pipe tunnel 113 is greater than the temperature of outside air and the temperature of the heat-conductive medium 114 in the pipe tunnel 113 may be overly high, the airflow driving devices 130 may be activated to drive outside air to flow into the flow paths 121. As such, air flowing into the flow paths 121 conducts heat exchanges with the heat-conductive structure 120 and the second plate surface 112, so as to absorb heat of the heat-conductive medium 114 in the pipe tunnel 113 and further dissipate excessive heat to the outside. Therefore, with favorable heat collection and heat dissipation efficiencies, the multifunction flat plate heat exchanger 100 of the present embodiment provides increased applications.

Further, when the airflow driving devices 130 are activated to allow air in the flow paths 121 to be exhausted to the outside, outside air may flow into the flow paths 121 from the first through holes 122. On the other hand, when the airflow driving devices 130 are activated to allow outside air to be sent into the flow paths 121, air sent into the flow paths 121 may be exhausted to the outside from the first through holes 122. In other words, the airflow driving devices 130 may be configured to increase flowing efficiency of air inside and outside the flow paths 121. In the present embodiment, an outer cover 160 may be selectively disposed at the multifunction flat plate heat exchanger 100 to be configured to cover the second plate surface 112 and the heat-conductive structure 120, so as to prevent the second plate surface 112 and the heat-conductive structure 120 from being damaged by external forces. On the other hand, the outer cover 160 may be a heat insulation cover made of a material with a low conductive coefficient. In this way, heat loss inside the multifunction flat plate heat exchanger 100 may be prevented and users or other people may also be prevented from being burned. A top surface 161 of the outer cover 160 has a plurality of second through holes 162. The second through holes 162 are communicated with the flow paths 121 through the first through holes 122. That is to say, the outer cover 160 is disposed without affecting air flow inside and outside the flow paths 121. In addition, one side of the outer cover 160 facing the airflow driving devices 130 is an opening 163, such that air flow inside and outside the flow paths 121 is not affected. The rest of the three sides of the outer cover 160 connecting the top surface 161 are side walls 164 abutted against the second plate surface 121 and are configured to limit air to flow to the inside the outer cover 160 or to the outside of the outer cover 160 only through the opening 163 and the second through holes 162. Note that a plurality of shielding plates (not shown) may be disposed at the outer cover 160 corresponding to the second through holes 162. The shielding plates (not shown) may be configured to close or half close the second through holes 162 to limit air flow.

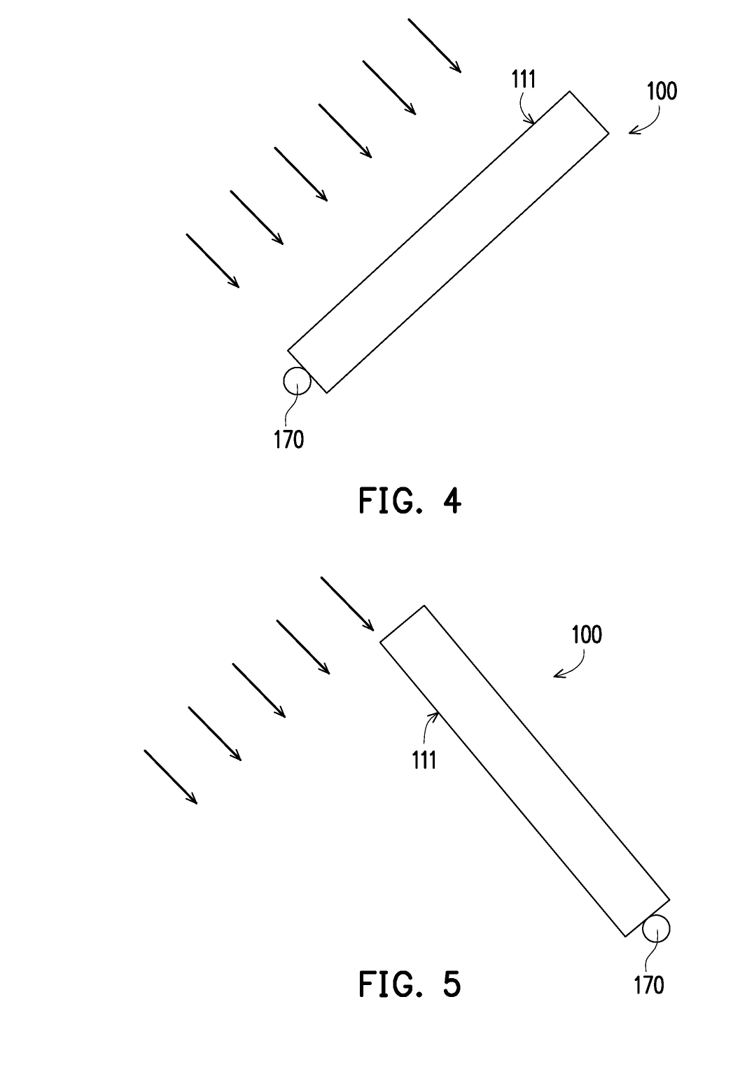

FIG. 4 and FIG. 5 are respectively schematic side views of the multifunction flat plate heat exchanger of FIG. 1 before and after being rotated. Note that the multifunction flat plate heat exchanger 100 of FIG. 1 is schematically illustrated in block views in FIG. 4 and FIG. 5, and above descriptions may be referenced for specific structures and thus a relevant description thereof is thus omitted. Referring to FIG. 4 and FIG. 5, the multifunction flat plate heat exchanger 100 may stand on the ground through a base (an adapter 170 of the base is schematically shown) and may be rotated relative to the ground through the adapter 170. The first plate surface 111 in FIG. 4, for example, faces the sun. When an internal temperature of the multifunction flat plate heat exchanger 100 is overly high, and the airflow driving devices 130 are required to be activated for heat dissipation (allowing outside air to flow into the flow paths 121 so as to conduct heat exchanges with the heat-conductive structure 120 and the second plate surface 112 and allowing air to be exhausted to the outside after the air flowing into the flow paths 121 absorbs heat of the heat-conductive medium 114 in the pipe tunnel 113, meaning that excessive heat is dissipated to the outside), the multifunction flat plate heat exchanger 100 may be rotated for changing angles. As such, as shown in FIG. 5, sun lights are unable to be projected on the first plate surface 111.

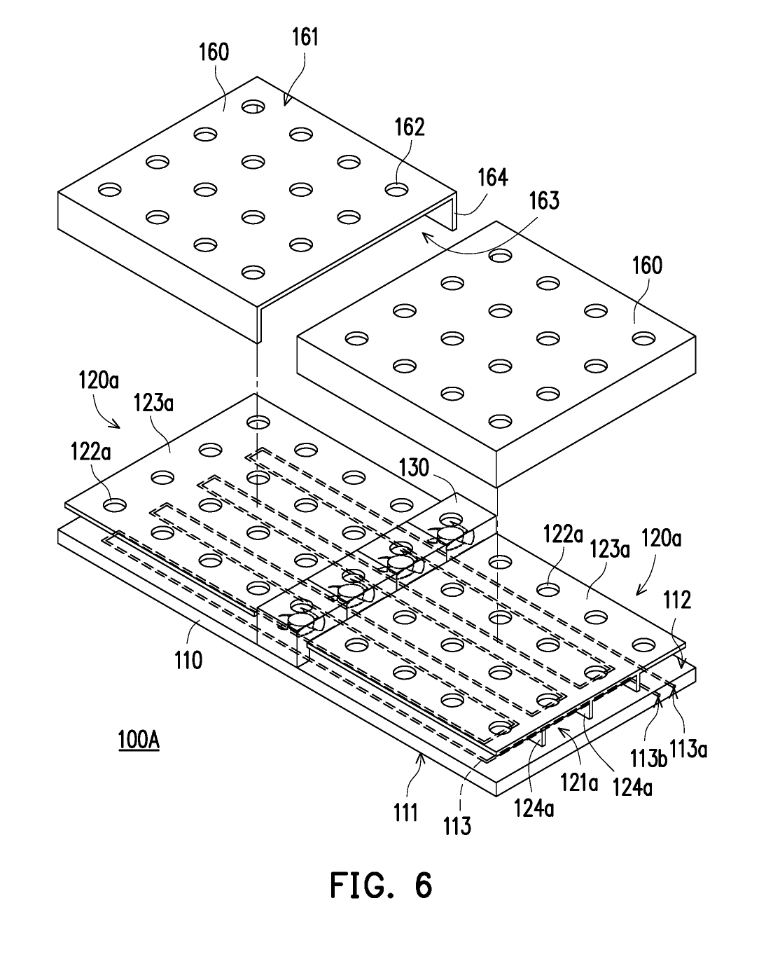

FIG. 6 is a schematic partial exploded view of a multifunction flat plate heat exchanger according to another embodiment of the invention. Referring to FIG. 6, a multifunction flat plate heat exchanger 100A of the present embodiment is approximately similar to the multifunction flat plate heat exchanger 100 of the foregoing embodiments; therefore, repeated description of the same technical contents is omitted, and only differences therebetween are illustrated. Please refer to the descriptions of the previous embodiments for the omitted contents, which will not be repeated hereinafter. Specifically, a heat-conductive structure 120a of the multifunction flat plate heat exchanger 100A is different from the heat-conductive structure 120 of the multifunction flat plate heat exchanger 100. The heat-conductive structure 120a includes a first plate portion 123a and a plurality of second plate portions 124a, wherein the first plate portion 123a and the second plate surface 112 are separated from each other and are, for example, parallel to each other. The first plate portion 123a is bonded to the second plate surface 112 through the second plate portions 124a, wherein the second plate portions 124a are arranged in parallel between the first plate portion 123a and the second plate surface 112. The second plate portions 124a may be perpendicular to the first plate portion 123a and the second plate surface 112. Each of flow paths 121a is defined by any adjacent two second plate portions 124a, a portion of the first plate portion 123a located between any adjacent two second plate portions 124a, and a portion of the second plate surface 112 located between any adjacent two second plate portions 124a. Herein, a plurality of first through holes 122a are located on the first plate portion 123a and are respectively located between one of the second plate portions 124a and another one of the second plate portions 124a.

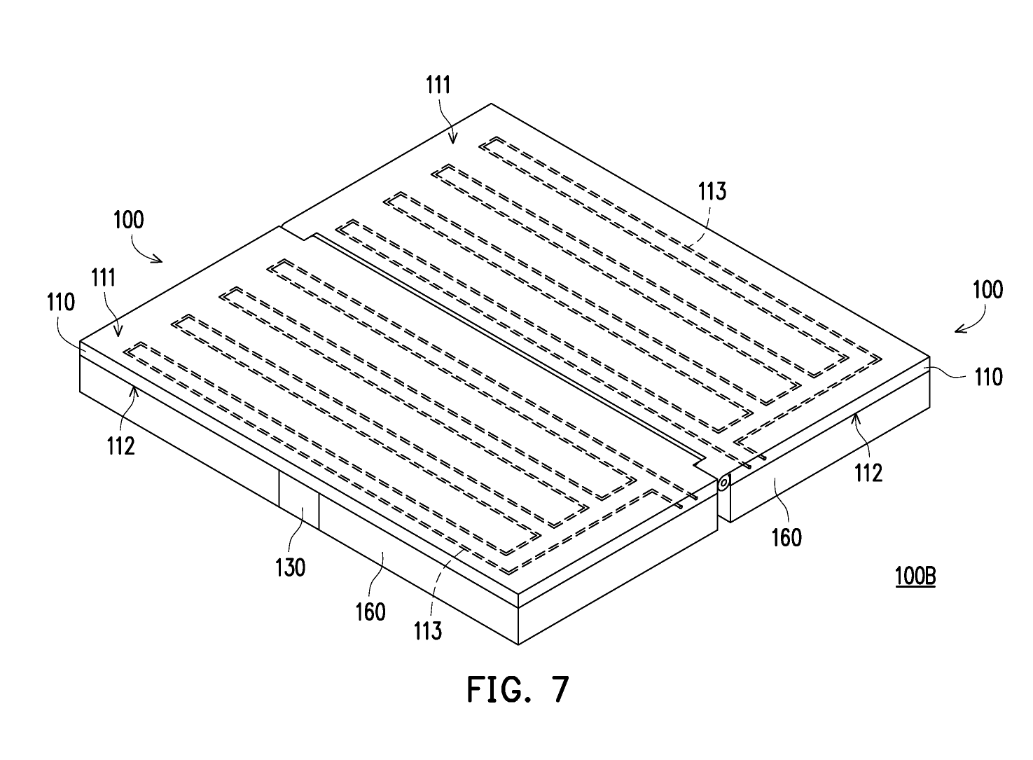

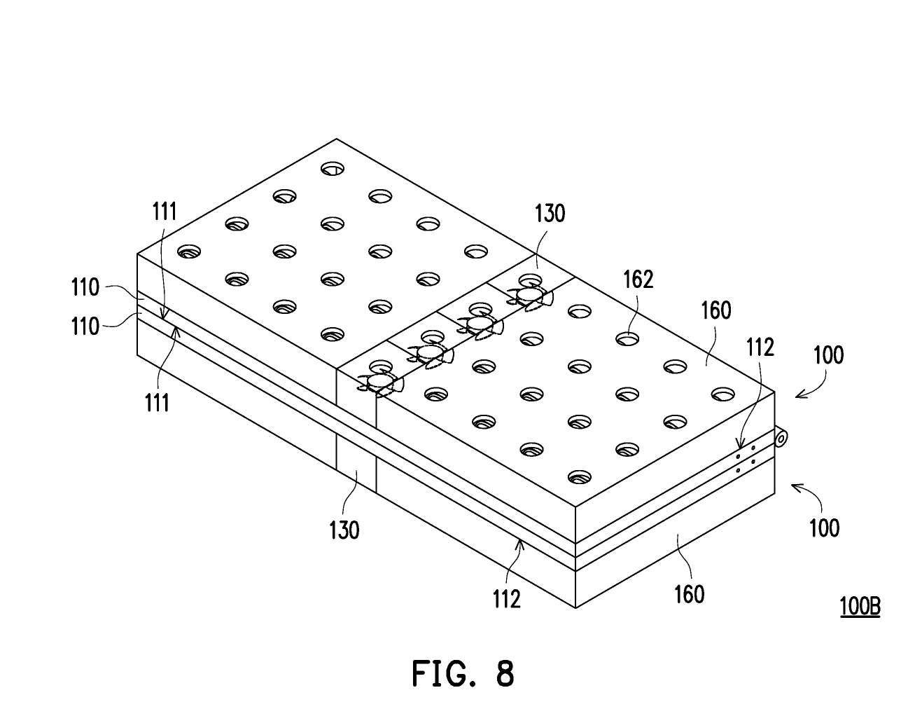

FIG. 7 and FIG. 8 are respectively schematic views of a multifunction flat plate heat exchanger in an unfolded state and in a folded state according to still another embodiment of the invention. Referring to FIG. 7 and FIG. 8, in the present embodiment, an internal structure of a multifunction flat plate heat exchanger 100B may be similar to the internal structure of the multifunction flat plate heat exchanger 100 or similar to the internal structure of the multifunction flat plate heat exchanger 100A or may be a combination combining the internal structures of the multifunction flat plate heat exchangers 100 and 100A. The multifunction flat plate heat exchanger 100B formed by two multifunction flat plate heat exchangers 100 pivoted to each other is taken as an example for explanation as follows. In an unfolded state, the two heat exchanging flat plates 110 pivoted to each other are arranged in parallel, wherein the first plate surfaces 111 of the two heat exchanging flat plates 110 are arranged in parallel to each other and are flushed with each other. At this time, the two first plate surfaces 111 face the sunlight. As such, the two heat exchanging flat plates 110 are rotatable relatively, and that the unfolded state is transformed to the folded state. In the folded state, the two first plate surfaces 111 face each other and are overlapped with each other, such that sunlight is unable to be projected on the two first plate surfaces 111. At this time, the outer cover 160 covering on one of the second plate surfaces 112 may face sunlight, and the other outer cover 160 covering on the other second plate surface 112 may be back to the sun. The airflow driving devices 130 may be activated to drive outside air to flow into the flow paths (see FIG. 2). As such, air flowing into the flow paths 121 (see FIG. 2) conducts heat exchanges with the heat-conductive structure 120 (see FIG. 2) and the second plate surface 112, so as to absorb heat of the heat-conductive medium 114 (see FIG. 3) in the pipe tunnel 113 (see FIG. 2) and further dissipate excessive heat to the outside.

In view of the foregoing, the multifunction flat plate heat exchanger provided by the embodiments of the invention can not only absorb solar radiation heat energy but also can guide other external environment heat (e.g., heat energy of air) into the multifunction flat plate heat exchanger for being absorbed through the airflow driving device when the internal temperature of the multifunction flat plate heat exchanger is overly low. Alternatively, outside air may be guided into the multifunction flat plate heat exchanger through the airflow driving device so as to conduct heat exchanges and to further dissipate excessive heat to the outside when the internal temperature of the multifunction flat plate heat exchanger is overly high. In other words, with favorable heat collection and heat dissipation efficiencies, the multifunction flat plate heat exchanger of the embodiments of the invention is able to provide increased applications.

Finally, it is worth noting that the foregoing embodiments are merely described to illustrate the technical means of the invention and should not be construed as limitations of the invention. Even though the foregoing embodiments are referenced to provide detailed description of the invention, people having ordinary skill in the art should understand that various modifications and variations can be made to the technical means in the disclosed embodiments, or equivalent replacements may be made for part or all of the technical features; nevertheless, it is intended that the modifications, variations, and replacements shall not make the nature of the technical means to depart from the scope of the technical means of the embodiments of the invention.

What is claimed is:

1. A multifunction flat plate heat exchanger, comprising:
a heat exchanging flat plate, having a first plate surface and a second plate surface opposite to each other, and a pipe tunnel located between the first plate surface and the second plate surface, the pipe tunnel is configured to allow a heat-conductive medium to flow therein;
a spectrum selectivity absorption layer, covering the first plate surface;
a light transmissive layer, covering the spectrum selectivity absorption layer, wherein the light transmissive layer and the first plate surface are respectively located at two opposite sides of the spectrum selectivity absorption layer;
at least one heat-conductive structure, disposed on the second plate surface, the at least one heat-conductive structure defines at least one flow path with the second plate surface and has a plurality of first through holes communicated with the at least one flow path; and
at least one airflow driving device, disposed at one side of the heat exchanging flat plate and the at least one heat-conductive structure, the at least one airflow driving device is disposed corresponding to the at least one flow path, the at least one airflow driving device is configured to drive outside air to flow into the at least one flow path or drive air inside the at least one flow path to be exhausted to an outside.

2. The multifunction flat plate heat exchanger as claimed in claim 1, wherein the at least one heat-conductive structure comprises a plurality of convex portions and a plurality of concave portions disposed alternately, wherein each of the convex portions is separated from the second plate surface, and each of the concave portions is bonded to the second plate surface.

3. The multifunction flat plate heat exchanger as claimed in claim 2, wherein a number of the at least one flow path is plural, and each of the convex portions is connected to one of the concave portions and another one of the concave portions adjacent to each other, so as to define one of the flow paths with the second plate surface.

4. The multifunction flat plate heat exchanger as claimed in claim 2, wherein the first through holes are located on the convex portions.

5. The multifunction flat plate heat exchanger as claimed in claim 1, wherein the at least one heat-conductive structure comprises a first plate portion and a plurality of second plate portions, wherein the first plate portion is bonded to the second plate surface through the second plate portions.

6. The multifunction flat plate heat exchanger as claimed in claim 5, wherein a number of the at least one flow path is plural, and wherein the second plate portions are arranged in parallel between the first plate portion and the second plate surface, and the first plate portion, the second plate portions, and the second plate surface define the flow paths.

7. The multifunction flat plate heat exchanger as claimed in claim 5, wherein the first through holes are located on the first plate portion and are respectively located between one of the second plate portions and another one of the second plate portions adjacent to each other.

8. The multifunction flat plate heat exchanger as claimed in claim 1, further comprising:
an outer cover, covering the second plate surface and the at least one heat-conductive structure, wherein the outer cover has a plurality of second through holes, and the second through holes are communicated with the at least one flow path through the first through holes.

9. The multifunction flat plate heat exchanger as claimed in claim 8, wherein the second through holes of the outer cover are configured to be selectively closed.

10. The multifunction flat plate heat exchanger as claimed in claim 1, wherein the at least one airflow driving device comprises an axial flow fan, a crosscurrent fan, a centrifugal fan, an air extracting pump, a blower, or a turbine.

11. A multifunction flat plate heat exchanger, comprising:
two heat exchanging flat plates, each of the two heat exchanging flat plates has a first plate surface and a second plate surface opposite to each other, and a pipe tunnel located between the first plate surface and the second plate surface, the pipe tunnel of each of the two heat exchanging flat plates is configured to allow a heat-conductive medium to flow therein, the two heat exchanging flat plates being pivoted to each other, the two first plate surfaces being arranged in parallel to each other and flushed with each other in an unfolded state, the two first plate surfaces face each other and are overlapped with each other in a folded state;
two spectrum selectivity absorption layers, respectively covering the two first plate surfaces;
two light transmissive layers, respectively covering the two spectrum selectivity absorption layers, wherein each of the two light transmissive layers and the corresponding first plate surface are respectively located at two opposite sides of the corresponding spectrum selectivity absorption layer;
two heat-conductive structures, respectively disposed on the two second plate surfaces, each of the two heat-conductive structures defining at least one flow path with the second plate surface of the corresponding heat exchanging flat plate and has a plurality of through holes communicated with the at least one flow path; and
at least two airflow driving devices, one of the at least two airflow driving devices is disposed at one side of one of the two heat exchanging flat plates and one of the heat-conductive structures, the other one of the at least two airflow driving devices is disposed at one side of the other one of the two heat exchanging flat plates and the other one of the two heat-conductive structures, the at least two airflow driving devices are respectively disposed corresponding to the at least two flow paths, and each of the at least two airflow driving devices is configured to drive outside air to flow into the corresponding at least one flow path or drive air inside the corresponding at least one flow path to be exhausted to an outside.
